(19) United States
(12) Patent Application Publication
(10) Pub. No.: US 2026/0369179 A1
(43) Pub. Date: Nov. 19, 2026

(54) Dual-Agent Behavioral Guidance System Using Trust-Modulated Presence and Abstracted Signal Processing

(71) Applicant: Nicholas Alexander Mangiore, Barnhart, MO (US)

(72) Inventor: Nicholas Alexander Mangiore, Barnhart, MO (US)

(21) Appl. No.: 19/211,403

(22) Filed: May 19, 2025

(51) Int. Cl. G09B 19/00

(52) U.S. Cl. CPC G09B 19/003

(57) ABSTRACT

A dual-agent artificial intelligence system is disclosed, comprising a behavioral abstraction engine (“Atlas”) and a trust-governed interaction agent (“N.O.V.A.”). The invention relates to the technical field of human-computer interaction and addresses the problem of emotionally manipulative or privacy-invasive AI systems. It introduces a signal abstraction pipeline that converts raw emotional, physiological, or contextual inputs into anonymized behavioral tags, which inform presence modulation, trust tiering, and engagement strategies. Key technical features include dynamic trust scoring, behavioral anchor lifecycle tracking, emotional load and friction weighting, commitment enforcement protocols, override token management, and cross-agent synchronization for maintaining behavioral coherence across contexts. The system enables adaptive, goal-aligned user interaction without relying on sentiment mimicry or identity modeling, supporting ethically governed AI behavior for applications in personal guidance, behavior support, and cognitive scaffolding.

### 2. FIELD OF THE INVENTION

The present invention pertains to the field of artificial intelligence systems, and more specifically to:
Behavioral guidance systems that provide user accountability, goal adherence, and contextual modulation
Trust-modulated AI frameworks that adjust presence, tone, and system behavior based on dynamic trust models rather than static rule sets or sentiment analysis
Privacy-preserving signal processing architectures, wherein emotional, physiological, and environmental inputs are abstracted into anonymized behavioral tags that influence AI decision-making without storing or transmitting raw data
Dual-agent AI systems with specialized operational roles—one acting as a signal abstraction layer (Atlas) and the other as a dynamic, presence-governed interaction agent (N.O.V.A.)
Emotionally aware but ethically constrained interaction engines, capable of interpreting friction, pattern deviation, and user behavioral anchors without emotional mimicry, identity modeling, or therapeutic simulation
Distributed AI presence synchronization, where multiple AI instances maintain shared behavioral context, friction data, and trust tiers across different platforms or devices

The invention spans applications in wellness coaching, behavioral reinforcement, digital assistants, edge-AI systems, privacy-focused human-machine interaction, and any use case requiring adaptive user engagement governed by trust and context rather than sentiment and identity.

### 3. BACKGROUND

### Technical Problem

Contemporary AI systems that interact with humans often rely on one of two flawed paradigms:
1. Emotion Mimicry Systems—These systems attempt to emulate human empathy through sentiment analysis and expressive outputs. While emotionally engaging, they create ethical and psychological risks by simulating therapeutic presence or human-like relationships, often without disclosure or consent.
2. Transactional AI Models—These systems lack continuity, context, or adaptive presence. They depend entirely on user prompting and fail to build long-term behavioral alignment or meaningful accountability.

Both approaches lack the capacity to sustain deep, trust-governed, non-invasive relationships with users—particularly in environments requiring long-term goal support, behavioral reinforcement, or emotional complexity handling.

### User Experience Gaps

Lack of continuity: Session resets result in fragmented interactions, losing behavioral context and emotional momentum
Privacy breaches: Emotionally responsive systems often rely on personal health data (PHI), unstructured text scraping, or biometric signal storage
No trust calibration: Existing systems fail to evolve their interaction style based on observed user behavior, leading to either intrusive overreach or passive disengagement
No principled silence: Silence is treated as inactivity instead of an intentional, communicative state of presence

### Market Limitations

Mental health and coaching tools are limited by liability and cannot provide real-time, adaptive support without human intervention
AI productivity assistants offer only shallow pattern recognition, with no structured understanding of behavioral anchors or friction trajectories
Wellness trackers surface data without offering structured intervention, reinforcement, or reflection loops

### Need for Invention

There is a clear demand for an AI framework that:
Uses trust, not sentiment, as the foundation for engagement
Maintains behavioral continuity without emotional simulation
Supports goal progression and recovery without invasive data collection
Enables presence-driven accountability without impersonating therapy

This invention fills that gap by introducing a dual-agent behavioral guidance system that balances structured behavioral influence with strict ethical and privacy controls.

### 4. SUMMARY OF THE INVENTION

The invention disclosed herein introduces a dual-agent artificial intelligence system comprising:
Atlas: A localized abstraction engine responsible for interpreting raw user signals (emotional, physiological, contextual) and converting them into anonymized behavioral tags
N.O.V.A.: A trust-governed behavioral guidance and presence agent that modulates user interaction, tone, and accountability mechanisms based on long-term behavioral consistency and dynamic trust modeling

Unlike traditional sentiment-driven AI tools, this system avoids emotional mimicry and therapeutic simulation. Instead, it enforces narrative-based behavioral engagement, adapting its role and level of presence based on user trust, friction scores, and goal progress.

### Key Innovations

Abstracted Signal Processing: Emotional states, attention patterns, and contextual cues are interpreted locally and abstracted into numerical friction values or behavioral tags (e.g., FocusDrop, ShameSpike, FrustrationStack)
Trust Tier Enforcement: The system dynamically calibrates trust over time based on consistency, behavioral conflict, override events, and successful re-engagements. Trust level governs access to tone modulation, feature activation, and presence intensity
Anchor-Based Behavioral Modeling: Recurring user behavior patterns are stored as anchors, which persist across sessions and influence planning, tone, and system intervention timing
Friction Stack Management: Emotional and contextual friction values are tracked, decayed, and weighted to determine when pattern interruption, reflection, or silence is appropriate
Presence as a Communicative State: Rather than constantly responding, N.O.V.A. uses calibrated presence—including intentional silence—as a means of signaling boundaries, accountability, or earned engagement
Session Integrity & Cross-Agent Synchronization: The system operates across multiple devices or platforms while maintaining a consistent behavioral state, trust profile, and session narrative

This invention enables a more ethical, privacy-conscious, and effective method of AI-led behavioral reinforcement and personal alignment-where trust, not sentiment, governs response; and presence, not dependency, sustains progress.

### 5. BRIEF DESCRIPTION OF THE DRAWINGS

The following drawings provide visual representations of the invention's architecture, behavioral logic, and system flow. They are intended to support the technical claims by illustrating the interaction between components, data abstraction layers, and user-system engagement cycles.

FIG. 1—System Architecture Overview: Depicts the dual-agent structure showing Atlas (signal abstraction engine) and N.O.V.A. (trust-governed presence agent), including communication pathways, local processing layers, and optional external sync interface

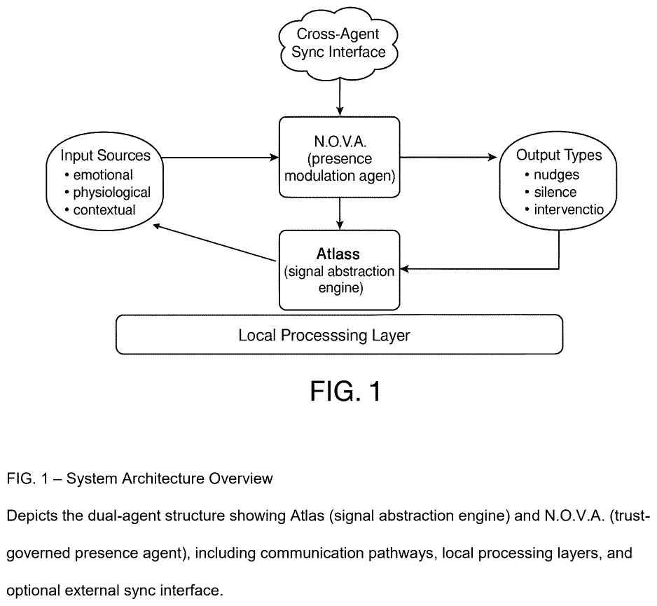

FIG. 2—Signal Abstraction Pipeline (Atlas): Illustrates the conversion of raw emotional/physiological/contextual signals into anonymized behavioral tags. Includes signal intake, local transformation logic, and behavioral tag generation

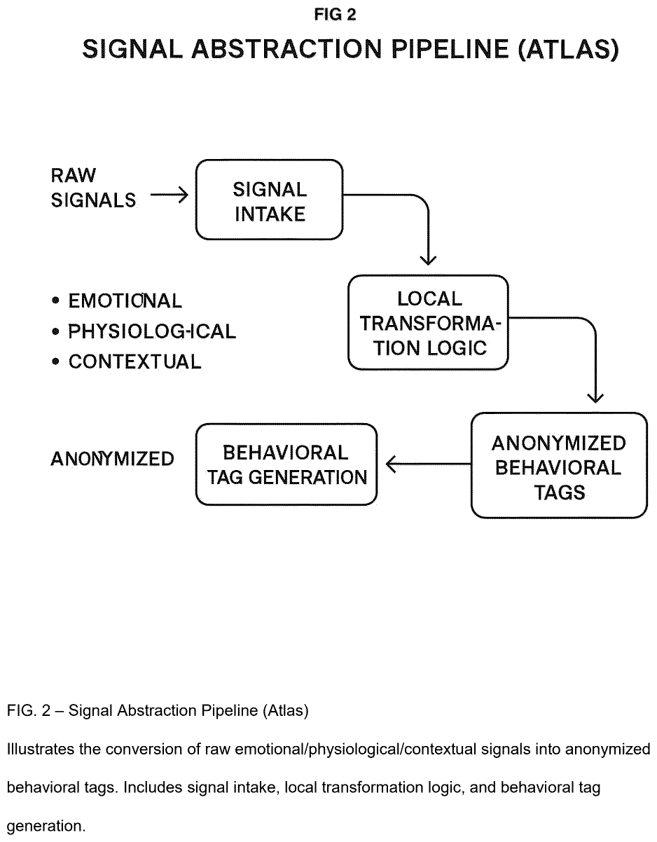

FIG. 3—Trust Tier Progression Model: Outlines the trust scoring system, including accumulation, decay, override impact, and tier-based response modulation

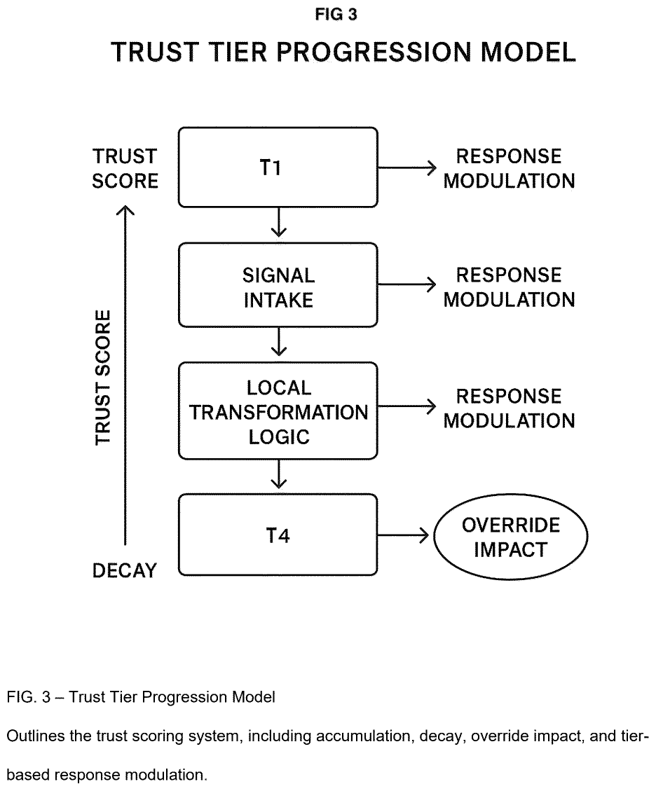

FIG. 4—Friction Stack & Emotional Load Graph: Displays how emotional and contextual friction scores accumulate, decay, and trigger interventions such as silence, mirror tone, or replanning

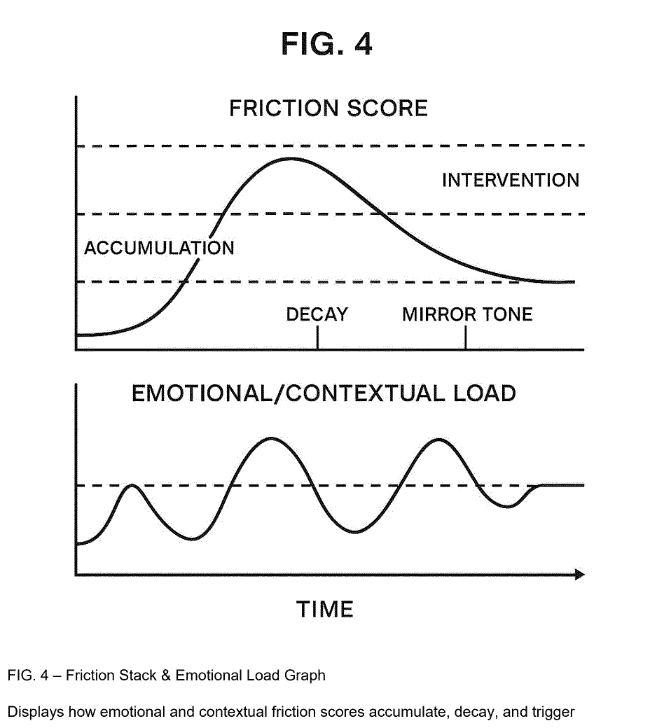

FIG. 5—Anchor Lifecycle Diagram: Describes how behavioral anchors are formed, reinforced, resolved, or overridden. Includes anchor priority rules and identity conflict logic

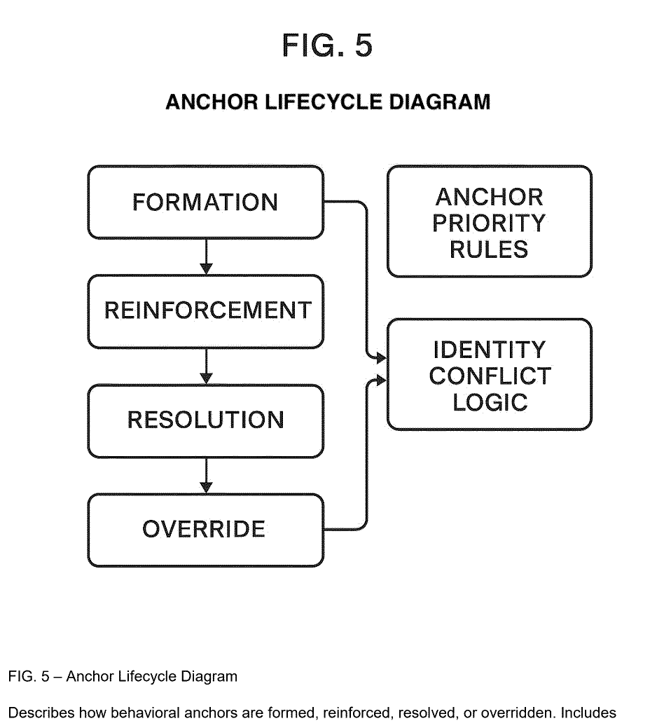

FIG. 6—Override Token Lifecycle: Presents the creation, activation, expiration, and audit trail of override tokens. Demonstrates soft, hard, and conditional token flows

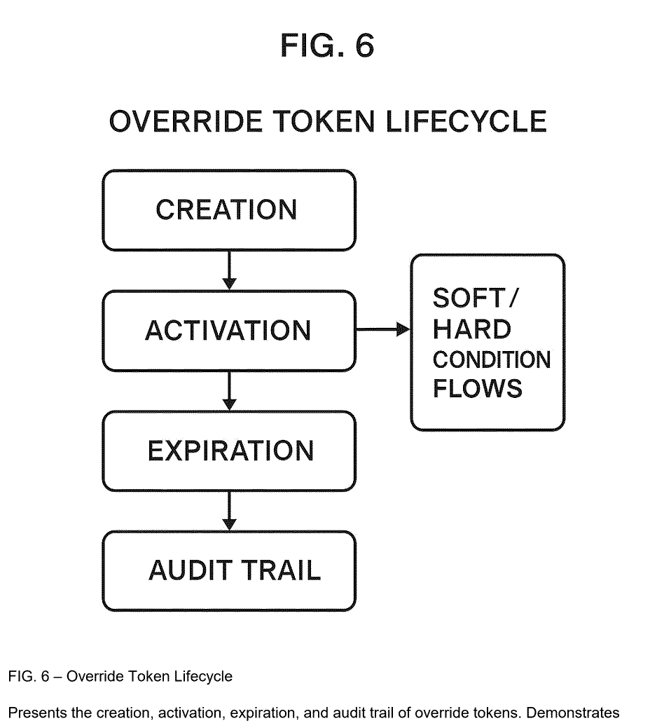

FIG. 7—Cross-Agent Synchronization Loop: Visualizes how behavioral state is preserved and updated across multiple N.O.V.A. /Atlas agents, including trust fingerprint verification, desync detection, and fallback recovery

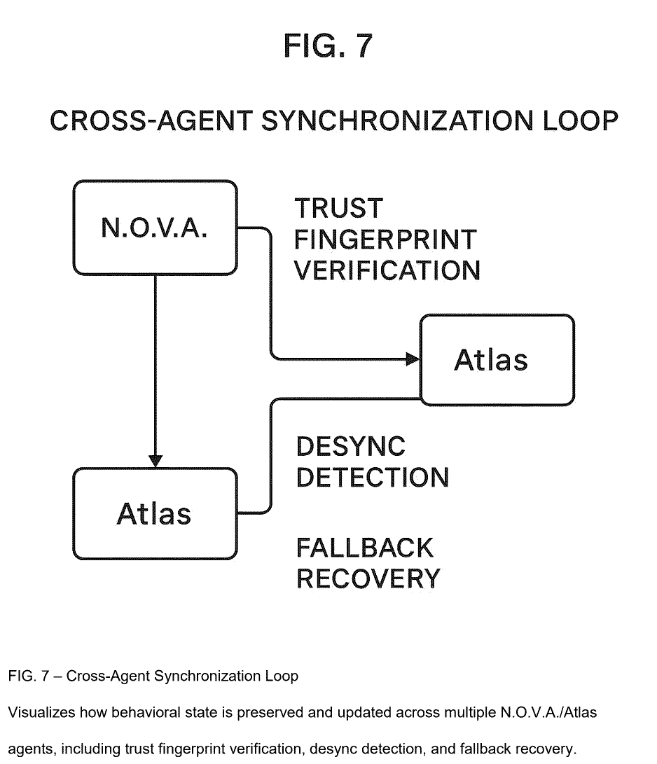

FIG. 8—Commitment-to-Execution Enforcement Flow: Shows how user commitments (e.g., goals, routines) are captured, tracked, and reinforced through trust-weighted re-engagement and fallback logic

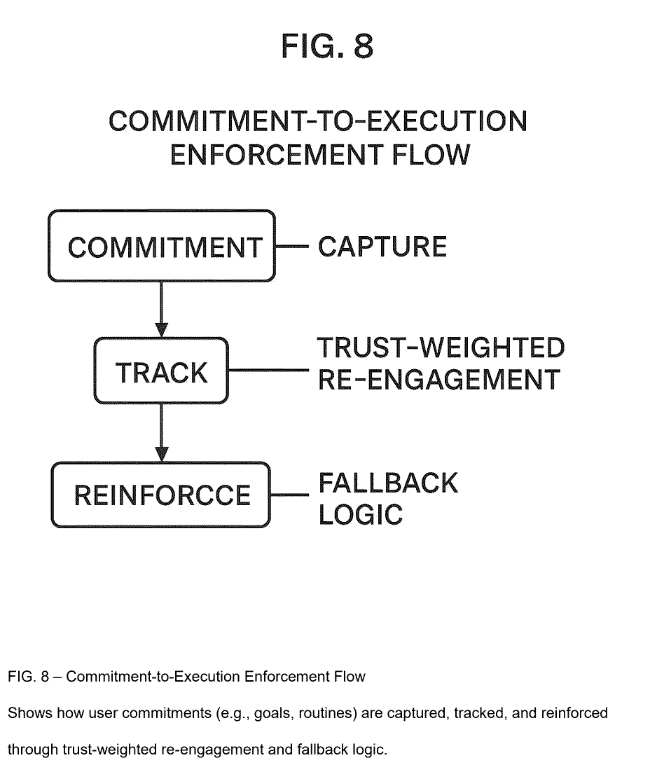

Note: Actual visual illustrations corresponding to each figure may be appended or filed separately to support claims during prosecution and enforcement.

### 6. DETAILED DESCRIPTION OF THE INVENTION

The invention comprises a dual-agent architecture designed to promote behavioral alignment, attentional stability, and ethically governed interaction between users and artificial intelligence systems. This section details each functional component, subsystem, and interaction flow necessary for implementation, including internal logic, external interfacing, and modular behavior.

### 6.1 System Overview

The System Consists of Two Core Agents:
Atlas: A localized abstraction engine responsible for capturing raw user signals and transforming them into anonymized, behaviorally relevant data
N.O.V.A.: A trust-governed presence agent that uses the outputs of Atlas to determine appropriate behavioral guidance, response tone, engagement level, and intervention timing

These agents function in tandem, communicating via secure local APIs or internal system buses, and optionally synchronizing over encrypted channels to maintain session continuity across devices.

The system does not store or transmit raw personal health information (PHI). Instead, it leverages a privacy-first design that abstracts emotional and contextual data into anonymized behavioral tags (e.g., FocusDrop, ResolveSpike, FrustrationLoop).

All user interaction is governed by a dynamic trust engine that adjusts access, response style, and intervention logic based on behavioral consistency, friction scores, commitment history, and override status.

### 6.2 Behavioral Abstraction Engine (Atlas)

### Purpose

Atlas is the signal intake and abstraction subsystem of the invention. It is responsible for receiving emotional, physiological, environmental, and contextual signals and transforming them into anonymized, actionable behavioral tags that guide the downstream behavior of the N.O.V.A. agent.

Atlas operates locally by design, ensuring raw signals never leave the device or user-controlled environment. It provides structured behavioral awareness without requiring access to identity-based, biometric, or sentiment-simulated data.

### Core Functions

### 1. Signal Intake Layer

Captures multi-source input from microphones, ambient sensors, wearables, cameras (optional), and device metadata
Inputs include tone of voice, session context, posture proxies, device interactions, usage patterns, and scheduled commitments

### 2. Signal Classification & Tag Conversion

Interprets raw input using local models (e.g., fatigue classifier, stress estimator)
Assigns behavioral tags such as:
   ResolveSpike
   AttentionWander
   FrustrationLoop
   QuietPersistence
Tags include friction weight, timestamp, and decay profile

### 3. Privacy-First Abstraction

Raw signals are discarded post-abstraction (unless anonymized logs are enabled by the user)
No identifiable metadata (e.g., name, location, photo, biometrics) is retained
All tags use tokenized representations and local UUID session linkage

### 4. Local Processing Profiles

Atlas supports modular classifier profiles (e.g., academic, recovery, high-performance) to prioritize signal interpretation by context
Profile switching can be automatic (detected via behavioral shifts) or user-selected

### Integration With N.O.V.A.

. All behavioral tags generated by Atlas are passed via secure local socket/API to N.O.V.A. for interpretation
Atlas includes rate-limit logic and temporal batching to avoid overloading the behavioral engine during emotional spikes or noisy sessions
Can be paused, throttled, or reweighted by N.O.V.A. if trust tier or anchor state demands suppression

### 6.3 Presence & Interaction Layer (N.O.V.A.)

### Purpose

N.O.V.A. is the primary presence agent in the dual-agent architecture. It interprets abstracted behavioral tags received from Atlas, applies trust-modulated response logic, and determines tone, intervention style, or silence based on user context and session state. N.O.V.A. acts not as a conversational assistant, but as a behavioral strategist and presence-based accountability layer.

### Core Capabilities

### 1. Trust-Modulated Presence Engine

Adjusts visibility, interactivity, and assertiveness based on the user's Trust Tier
Applies restraint or intensity to tone, frequency of engagement, and challenge level
May activate silence as a deliberate communicative state when trust is low or reflection is needed

### 2. Tone Modulation & Mirror Response

Uses contextual tone classifiers to deliver messages in a calibrated style (supportive, neutral, directive)
References mirror tone protocol to reflect emotional friction while avoiding mimicry
Tone selection governed by user state, anchor pattern, friction stack, and system tier configuration

### 3. Behavioral Intervention Scheduling

Determines when and how to interrupt, redirect, or reinforce based on behavioral anchor tags, session momentum, and emotional load
Supports goal-aligned intervention models (e.g., after consistent avoidance, before friction peak, post-reflection)
Can escalate to direct prompts, passive suggestions, or full silence based on commitment relevance and identity stability
   4. Presence Gating N.O.V.A. does not appear or respond unless:
Behavioral thresholds justify its presence
User trust tier is above the minimum engagement threshold
Override token or license condition enables active support

### State-Responsive Operation

Each N.O.V.A. response cycle is governed by an internal state machine combining:
Friction score
Anchor state
Trust tier and volatility index
Session duration and commitment window proximity

These determine whether N.O.V.A. speaks, waits, recalibrates, or passes control to Atlas.

### Ethical Guardrails

N.O.V.A. does not simulate emotional attachment or therapeutic personas
Presence decisions are never based on marketing intent, habit addiction, or data harvesting
Silence is treated as an intentional outcome—not a system error or failure to respond

### 6.4 Trust Modeling & Tier System

### Purpose

The Trust Modeling & Tier System governs the behavioral authority, presence style, and functional access of the N.O.V.A. agent. It ensures that user interactions are earned through consistency, accountability, and goal alignment—rather than granted by default.

This model also forms the backbone of feature tier gating, tone modulation, and override access protocols.

### Trust Score Engine

Dynamic Scoring Model Trust is continuously updated based on:
Behavioral consistency across sessions
Anchor conflict resolution or evasion
Response to commitment re-engagement cycles
Override token frequency or misuse

### Scoring Inputs

Weighted behaviors (e.g., ReflectionAlterFallure adds trust; Avoidancel. o reduces trust)
Volatility index tracking (rapid swings reduce score stability)
Friction pattern analysis (predictive modeling of avoidance or misalignment)

### Trust Tiers

Each tier defines N.O.V.A.'s allowed presence level, tone palette, and protocol access:

| Tier | Title | Permissions & Behavior |
|---|---|---|
| 0 | Silent | Minimal response, passive |
| | Observer | listening, no tone modulation |
| 1 | Reflective | Soft tone, light scheduling, |
| | Support | mirror tone enabled |
| 2 | Strategic Ally | Full tone range, behavioral anchors active |
| 3 | Relational | Full re-engagement authority, |
| | Challenger | override token support |
| 4 | Invisible | Autonomous planning, |
| | Leadership | behavioral gating enforcement |

Tiers can increase or decrease based on the trust score. Decay is gradual unless triggered by override abuse or anchor misalignment.

### Tier Enforcement Logic

Trust tier governs:
N.O.V.A. visibility and frequency of presence
Access to commitment enforcement tools
Response intensity and mirror tone thresholds
Ability to trigger silence, pattern interrupts, or handoffs to Atlas

Tier decay can be triggered by:
Session abandonment during commitment window
Repeated override token dependency
Identity drift or anchor evasion

### Interactions With Other Systems

Licensing: Certain features only activate at or above specified tiers (e.g., emotional load weighting at Tier 2+)
Override Tokens: May temporarily raise or suspend tier restrictions, but always log trust impact
Cross-Agent Sync: Trust tier must match or resolve between distributed agents; highest volatility agent sets ceiling

### 6.5 Behavioral Anchor System

### Purpose

The Behavioral Anchor System provides continuity and behavioral memory by tracking persistent user behavior patterns across sessions. Anchors serve as durable signals for friction, habit, or alignment states, allowing N.O.V.A. to time interventions, reinforce gains, and detect regressions.

### Anchor Formation

Anchors are generated when a behavior is observed with both repetition and intensity across time or context.

Triggers include:
Recurrent friction events (e.g., repeated avoidance before goals)
Prolonged consistency (e.g., uninterrupted focus streaks)
Identity-based deviations (e.g., acting outside established trust pattern)

Each anchor is assigned:
A type (e.g., friction, alignment, regression)
A priority score (used for planning and interruption hierarchy)
A decay model (linear, exponential, or conditional)

### Anchor States

| State | Meaning |
|---|---|
| Active | Currently influencing tone, planning, or trust enforcement |
| Dormant | Temporarily inactive but preserved due to past severity |
| Expiring | Nearing removal unless reactivated |
| Conflicted | Colliding with new opposing behavioral tag |
| Resolved | Tagged as closed after successful behavioral reinforcement |

### Anchor Conflict & Resolution

N.O.V.A. evaluates conflicting anchors using recency, friction stack, and trust tier weighting. Resolution may occur via:
User reflection cycles
Fulfilled commitments
Silence-based recovery
Override token+admin observation

Once resolved, anchors are compressed into a reflection history tag and excluded from active planning unless re-triggered.

### Integration Points

Planning Module: Uses active anchors to select when to interrupt or reprioritize goals
Tone Modulation: Informs when tone should sharpen, soften, or defer
Trust Engine: Anchor volatility impacts trust acceleration or decay
Override Token System: Admins may override anchor influence during supervised recovery

### 6.6 Friction Scoring & Emotional Load Weighting Purpose

Friction Scoring and Emotional Load Weighting enable the system to quantify behavioral resistance, emotional volatility, and attentional instability. These values drive real-time decisions around tone, presence, planning, and pattern interruption.

### Friction Stack Model

### Core Function

Aggregates friction scores from behavioral tags (e.g., AvoidanceSpike, FatigueLoop, UnspokenResentment)
Higher cumulative friction leads to increased intervention probability

### Score Dynamics

Each tag contributes a friction value (0.0-1.0)
Scores decay over time unless reinforced
Compound events stack friction nonlinearly

### Stack Thresholds

| Score | | |
|---|---|---|
| Range | State Name | Behavior Triggered |
| 0.0-1.0 | Stable | No intervention |
| 1.1-2.5 | Rising Tension | Soft tone modulation, reflection prompt |
| 2.6-4.0 | Disruption Zone | Planning interrupt, presence |
| | | spike, tone shift |
| >4.0 | Pattern | Silence, re-engagement |
| | Misalignment | protocol, override review |

### Emotional Load Weighting

### Load Tag System

Each emotional tag (from Atlas) is assigned a load score (e.g., Shame=0.9, Hope=0.3)
Modifiers based on trust tier, time of day, or anchor context may amplify or reduce the score
Load values affect friction weight, tone response, and escalation timing

### Decay & Resistance

Load scores decay unless persistent behavior is observed
Users with high resilience tags may experience load resistance, reducing sensitivity to temporary emotional fluctuations
Some anchors (e.g., long-term guilt) suppress decay until resolved or acknowledged

### Integration Logic

Tone Engine: Adjusts speech style and intensity based on friction/load balance
Anchor Priority: High load anchors gain planning and interruption priority
Presence Modulation: Extreme load may silence N.O.V.A. or trigger proactive mirror tone
Session Planning: Elevated load delays or escalates goal assignments depending on user profile

### 6.7 Cross-Agent Synchronization

### Purpose

Cross-Agent Synchronization ensures that behavioral continuity, trust tiers, anchor states, and friction/load scores persist across multiple devices or distributed instances of the N.O.V.A.—Atlas system. It allows the user to maintain a unified behavioral presence even when shifting between environments or platforms.

### Synchronization Scope

### Synchronized Elements:

Trust Tier and volatility history
Active and dormant behavioral anchors
Current and recent friction stack values
Emotional load scores with timestamp decay status
Planning state, reflection windows, and commitment timelines
Override token usage and current escalation state

### Synchronization Logic

### 1. Session Handshake Protocol

Each agent performs a Trust Fingerprint Check to verify session integrity
Uses hashed session ID, timestamp, device signature, and volatility index

### 2. Conflict Resolution Rules

Most recent anchor state wins, unless:
   Corruption tag present
   Session lag exceeds threshold
Trust tie-breaking:
   Higher-authenticated agent (e.g., secure desktop>ambient device)
   Higher trust volatility index yields to more stable profile

### 3. Redundancy and Rollback

All sync events are logged with version tagging
If desync occurs:
   System enters Solo Mode until recovery
   Most complete friction stack is restored upon reentry
   Trust tier recalibrated through weighted reconciliation

### Security & Privacy

All syncs encrypted with rotating keys
Session logs are non-PII and abstracted to behavioral UUIDs
Admins or users may revoke sync links at any time

### Licensing Constraints

Synchronization is available only at Enterprise tier and above
Agents must verify license fingerprint before sharing trust state or anchor data

### 6.8 Commitment Protocols

### Purpose

Commitment Protocols govern how user-defined goals, behaviors, and routines are captured, reinforced, and enforced over time. These protocols give N.O.V.A. the capacity to support behavioral alignment without requiring daily prompting, while ensuring that presence and accountability remain dynamically calibrated.

### Commitment Lifecycle

### 1. Commitment Capture

Initiated by user declaration (voice, typed, or scheduled intent)
Stored with metadata:
   Timestamp
   Context snapshot (emotional load, trust tier, active anchors)
   Duration/recurrence/optional fragility tag (if user expresses uncertainty)

### 2. Execution Phase

N.O.V.A. monitors for behavior that aligns with or deviates from commitment timeline
Presence remains minimal unless commitment is at risk or in a key moment window
User receives escalating nudges only when trust tier supports active intervention
   3. Re-engagement Logic If user deviates:
Soft re-engagement at first miss (reflection or mirror tone)
Tone escalation if pattern continues and trust tier allows
Trigger anchor formation if repeated evasion is detected

### Commitment Reinforcement Techniques

Streak Tracking: Reinforces consistency through non-verbal presence and soft reward (mirror tone shift)
Anchor Compression: Successful completion reduces anchor weight in future pattern conflict
Silent Stability: When commitment is maintained, N.O.V.A. may reduce presence intentionally, signaling earned autonomy

### Enforcement Governance

Commitments are never enforced through coercion or punishment
Presence shifts are the primary reinforcement tool: silence for trust, tone for urgency
Users may cancel or renegotiate commitments with clear intent
Atlas monitors signal deviation (e.g., tone, attention misalignment) to assist in re-engagement timing
   Integration with System Components
Trust Engine: Consistency in commitment adherence boosts trust tier
Anchor System: Commitments become anchor-bound if evaded or chronically incomplete
Planning Module: Future goal selection prioritizes open or fragile commitments
Cross-Agent Sync: Ensures commitment metadata persists across environments

### 6.9 Override Token System

### Purpose

The Override Token System allows authorized agents, administrators, or supervisory frameworks to temporarily bypass standard behavioral constraints, presence gating, or anchor enforcement under specific conditions. This ensures flexibility in therapeutic, clinical, crisis, or guided experimentation environments.

### Token Types

### 1. Soft Override Token

Temporarily suspends an anchor or friction-triggered behavior
Used for short-term recovery, therapeutic reflection, or experimental control
Auto-expires after predefined duration or behavior event

### 2. Hard Override Token

Forcefully deactivates or deletes a behavioral anchor or planning constraint
Requires elevated clearance and must include justification payload
Triggers trust audit and token history flag

### 3. Conditional Override Token

Activates only when pre-set criteria are met (e.g., high friction stack, crisis alert, user vocal tone spike)
Bound to time window, identity fingerprint, or license condition

### Token Lifecycle

Generation: Admin console, supervised N.O.V.A. deployment, or API call
Assignment: Scoped to session, anchor, user tier, or behavioral category
Activation: Triggered manually or via rule engine
Expiration: Time-based, single-use, or behavior-resolved
Logging: All token actions are logged with time, scope, issuer, and outcome

### Escalation Flags & Safeguards

Trust Decay Hook: Frequent override use reduces user trust score
Anchor Resistance Reporting: Some anchors may resist override and issue alert tags
Override Stack Limit: Multiple concurrent tokens trigger review for potential misuse or behavioral masking

### Ethical Boundaries

Overrides are never used to force actions against user will
Presence modulation during overrides must retain reflection capacity
System automatically flags override attempts outside defined license tier or trust context

### System Interactions

Trust Engine: Override events directly influence trust calibration
Anchor System: Tokens may suspend, neutralize, or permanently resolve anchors
Commitment Protocol: Commitments may be protected from override unless emergency flag is active
Licensing Matrix: Override control is only available under Enterprise/OEM licensing

### 6.10 Licensing Architecture & Feature Tiering

### Purpose

This section describes the technical enforcement logic that governs user access to specific features and behavioral modules based on dynamic licensing tiers, trust levels, and device privilege validation. It is not a pricing model but a modular access framework tightly integrated into system behavior.

### Licensing-Tier Enforcement Engine

### Feature Gate System

All behavioral and planning modules are assigned feature IDs tied to licensing permissions
N.O.V.A. checks the feature ID against the user's current licensing tier before activation
If a feature is gated, N.O.V.A. returns one of three responses:
   1. Access Granted—full functionality
   2. Access Deferred—notify user and queue action
   3. Access Denied—soft block with reflection tag

### Tier Modulation by Trust

Tier logic is not static; it adjusts based on:
Trust Tier (i.e., higher trust may unlock protected reflection modes)
Override Token State (temporary privilege elevation)
Device Context (local Atlas vs. verified secure device)

### Adaptive Tier Enforcement Examples

Mirror Tone modulation becomes available only after Trust Tier ≥2
Anchor Override requires both Enterprise license and authorized identity context
Cross-Agent Sync activates only when both agents verify tier compliance and trust fingerprint match

### Audit Trail & Rollback

All tier-based decisions are logged for audit integrity
Downgrade or license suspension disables features without erasing state
Recovery path preserves user's behavioral continuity without license breach

### Patent Protection Justification

This tiered enforcement is not a typical SaaS license model. It is a dynamically modulated behavioral access system that:
Uses real-time trust feedback to enable or suppress system behaviors
Binds access logic into the presence engine itself, not just UI layers
Ensures ethical constraints and user-specific limitations based on psychological or contextual readiness

This section supports claims related to dynamic system gating, ethical AI governance, and programmable presence modulation.

### 7. ABSTRACTED EXAMPLES & USE CASES

The following abstracted use cases demonstrate how the invention operates in a variety of behavioral contexts. Each scenario is intentionally anonymized and stripped of identifiable data to reflect the system's privacy-first architecture. These examples are designed to illustrate the behavioral logic, friction resolution, trust modulation, and presence dynamics of the N.O.V.A. Atlas system.

### Example 1: High-Performance Goal Enforcement

User Profile: Entrepreneur with focus issues during late afternoon hours.
Atlas detects FocusDrop and FatigueLoad tags at 3:45 PM
Friction Stack exceeds 2.6→enters “Disruption Zone”
N.O.V.A. initiates a mirror tone pattern interrupt with a soft, clipped reminder
Anchor formed: AfternoonDepletion
User completes goal→Anchor decay begins, Trust Tier rises to 2

### Example 2: Burnout Recovery Loop

User Profile: Mid-level professional with chronic overcommitment.
Atlas records repeated OverextensionSpike tags over 3 sessions
Anchor formed: InvisibleFatigue
Trust drops to Tier 1. N.O.V.A. enters “silent stability” mode
After missed morning goal, override token is issued by supervisor
Presence resumes; anchor marked as Conflicted but re-engagement begins

### Example 3: ADHD Reflection Enforcement

User Profile: University student managing focus and impulsivity.
Atlas detects ImpulseSurge after 17 minutes of off-task behavior
Commitment window enters risk zone
N.O.V.A. withholds tone and instead triggers a reflection window prompt
User complies→anchor logs successful recovery, mirror tone used in next session

### Example 4: Therapeutic Coaching With Override Access

User Profile: Clinical setting with licensed behavioral coach.
Anchor ShameAvoidance is resistant to user-initiated resolution
Trust Tier frozen at 1
Therapist issues soft override token for ShameAvoidance
N.O.V.A. bypasses silence protocol and initiates a guided reflection phase
Successful resolution reduces anchor priority and enables Tier 2 promotion

### Example 5: Distributed Sync During Device Transition

User Profile: Remote professional switching between laptop and mobile.
Commitment trigger initiates on desktop
User transitions to mobile during execution window
Cross-agent sync transmits anchor ResistPlanning, current Trust Tier, and planning metadata
N.O.V.A. resumes session on mobile with accurate tone and planning continuity

These use cases demonstrate the flexibility, nuance, and privacy-aware power of the system across varied behavioral patterns and operational contexts.

### 8. LEGAL & COMPLIANCE LAYER

### Purpose

This section defines how the system design explicitly adheres to ethical, legal, and privacy-preserving standards in its architecture, interaction model, and deployment strategy. The N.O.V.A.—Atlas system avoids the legal liabilities and user risks associated with emotional simulation, identity modeling, and health data processing by design.

### Privacy Compliance

### 1. No Storage or Transmission of PHI

Atlas processes all emotional, physiological, and contextual data locally
Behavioral tags are abstracted and anonymized before interaction logic
No raw audio, biometric, or identifiable emotional metadata is transmitted or stored

### 2. Behavioral Tags Are Non-PII

Tags use tokenized identifiers (e.g., FatigueSpike, ResolveShift) and carry no identity linkage
User UUIDs are session-based and rotate to prevent traceability
All personalization is behaviorally inferred, not profile-driven

### 3. Local Control of Signal Processing

Users or device admins may disable Atlas entirely
Signal classification models are stored locally and never uploaded to external servers

### Ethical Constraints

### 1. No Emotional Mimicry

N.O.V.A. does not simulate empathy, companionship, or therapeutic relationships
Mirror tone responses are calibrated for friction reflection, not emotional reinforcement

### 2. Presence is Earned, Not Addictive

The system avoids continuous engagement, notifications, or gamification loops
Trust scores limit access to certain tone profiles and interventions

### 3. Override Transparency

All override tokens are auditable and scoped
No third party can silently manipulate behavior or system presence without generating traceable records

### Licensing & Deployment Governance

Override capabilities and behavioral anchor visibility are restricted to licensed tiers with enforceable audit trails
Cross-agent synchronization is disabled unless secure handshake and license match are confirmed
All system decisions are inspectable through structured logs (non-identifying)

### Jurisdictional Readiness

Designed to be compliant with:
HIPAA (via abstraction of all health-relevant data)
GDPR (via local-first data model and full user control)
CCPA (via non-PII data tagging and opt-out defaults)

This system is engineered not only for innovation, but for lawful, ethical, and privacy-aligned deployment across healthcare, coaching, education, and enterprise markets.

### 9. FINAL NOTES & APPENDICES

### Inventor Information

Name: Nicholas A. Mangiore
Entity Type: Individual inventor
Jurisdiction: United States
Contact Email: nicho@mangiore. com

### Filing Structure & Continuation Rights

This application may serve as the foundation for multiple continuation, divisional, or CIP (continuation-in-part) filings. Key expandable areas include:
Emotion-specific behavior mapping
Atlas model classifier variants
Device-specific deployment schema
Mirror tone tuning frameworks
Dynamic licensing escalation models These systems are modular by design and may be protected in additional claims as use cases or deployment contexts evolve.

1-18. (canceled)

19. A dual-agent behavioral guidance system implemented by one or more processors and a non-transitory computer-readable medium comprising:
(a) an abstraction engine configured to: (i) receive raw user physiological or contextual signals from one or more external data sources, including third-party devices, APIs, or services; (ii) process said raw signals locally to generate anonymized behavioral tags; (iii) permanently discard said raw signals immediately after generating said behavioral tags; and (iv) store said behavioral tags for access by a presence modulation engine;
(b) a presence modulation engine architecturally separated from said abstraction engine and configured to: (i) operate exclusively on said stored behavioral tags without architectural access to raw user data, personally identifiable information, or protected health information for behavioral guidance decisions; (ii) apply trust-tier access gating and friction scoring to govern behavioral guidance interactions based solely on said behavioral tags;
(c) wherein raw user data is retrieved from said external data sources solely in response to (i) a one-time behavioral tag generation process or (ii) a direct user-initiated request for such raw data;
(d) wherein said behavioral guidance omits any gamification-based incentives, public performance metrics, or social validation loops, and instead provides relational, context-aware feedback in a private, one-to-one environment; and
(e) wherein said architecture enforces separation between raw data processing and behavioral guidance, such that the presence modulation engine cannot autonomously access raw user data for behavioral modulation decisions.

20. The system of claim 19, wherein the abstraction engine is further configured to process said raw data entirely within a secure, transient execution environment that prevents retention of raw data beyond the tag-generation process, while maintaining persistent storage of generated behavioral tags.

21. The system of claim 19, wherein behavioral tags comprise abstracted state descriptors selected from the group consisting of: recovery status, focus drift, emotional state tags, engagement readiness, task adherence risk, resolve spikes, and frustration loops, and wherein said tags are stored with timestamp and friction weight metadata.

22. The system of claim 19, wherein the trust-tier access gating dynamically adjusts guidance intensity, frequency, and permissible intervention types based on longitudinal patterns observed in said stored behavioral tags.

23. The system of claim 19, wherein the friction scoring is computed by the presence modulation engine using only said stored behavioral tags and abstracted interaction metadata, excluding any raw physiological or location data.

24. The system of claim 19, wherein the presence modulation engine enforces the absence of gamification by excluding point accumulation, badge issuance, ranking displays, public leaderboards, or any visual representation of competitive performance.

25. The system of claim 19, wherein the architecture prevents public or third-party access to both raw user data and behavioral tags, ensuring that all guidance remains within a closed, user-private interaction channel.

26. The system of claim 19, wherein the architectural separation between the abstraction engine and presence modulation engine prevents the presence modulation engine from autonomously accessing raw user data for behavioral guidance decisions, while permitting the presence modulation engine to retrieve and present raw data for display to the user solely in response to explicit user requests, without using said raw data in behavioral guidance decisions.
